(19) United States
(12) Patent Application Publication
(10) Pub. No.: US 2013/0185793 A1
(43) Pub. Date: Jul. 18, 2013

(54) Apparatus and Method for Tracking Network Path

(71) Applicants: Hyun Cheol Jeong, Seoul (KR); Seung Goo Ji, Seoul (KR); Tai Jin Lee, Seoul (KR); Jong II Jeong, Seoul (KR); Hong Koo Kang, Seoul (KR); Byung Ik Kim, Seoul (KR)

(72) Inventors: Hyun Cheol Jeong, Seoul (KR); Seung Goo Ji, Seoul (KR); Tai Jin Lee, Seoul (KR); Jong II Jeong, Seoul (KR); Hong Koo Kang, Seoul (KR); Byung Ik Kim, Seoul (KR)

(21) Appl. No.: 13/676,687

(22) Filed: Nov. 14, 2012

(30) Foreign Application Priority Data
Dec. 9, 2011 (KR) 10-2011-0132050

(51) Int. Cl. H04L 29/06

(52) U.S. Cl. CPC H04L 63/1408
USPC 726/22

(57) ABSTRACT

An apparatus and method for effectively tracking a network path by using packet information generated when visiting a Web page are provided.

According to embodiments of the invention, referrer information, seed information, and arrival information are extracted by using HTTP packet information generated while a particular Web page is being executed, whereby an infection path of malicious codes generated in several Web pages can be checked, thus preventing infection of a malicious code generated in Web pages.

### CROSS-REFERENCE TO RELATED PATENT APPLICATIONS

This patent application claims priority to Korean Patent Application No. 10-2011-0132050, filed Dec. 9, 2011, the entire teachings and disclosure of which are incorporated herein by reference thereto.

### FIELD OF THE INVENTION

The present invention relates to an apparatus and method for tracking a network path and, more particularly, to an apparatus and method for tracking a network path and, more particularly, to an apparatus and method for effectively tracking a network path by using packet information generated when visiting a Web page.

### BACKGROUND AND DESCRIPTION OF THE RELATED ART

In general, in most cases, information items sent from several servers are collectedly posted on a Web page. If certain information item has a malicious code (i.e., malware or malicious software), the malicious code may have been planted by a server or a start server (i.e., a disseminator server) in several paths, rather than by a server that manages a Web page.

In such a case, it is not easy to locate a disseminator server that has generated the malicious code. Recently, however, a technique for tracking a network path to locate a source of a malicious code has been presented, but a technique for tracking a network path to locate a malicious code planted in a Web page has yet to be provided.

### SUMMARY OF THE INVENTION

An aspect of the present invention provides an apparatus and method for tracking a network path capable of locating a malicious code disseminator in a Web page by using HTTP packet information among packet information generated when visiting a Web page.

Features of the present invention to achieve the object of the present invention and perform characteristic functions of the present invention as mentioned above are as follows.

According to an aspect of the present invention, there is provided an apparatus for tracking a network path, including: a packet extraction unit configured to extract only an HTTP packet among all the packets generated while a certain Web page is being executed; a referrer information extraction unit configured to extract first referrer information indicating start of the Web page and second referrer information indicating start of a different Web page from the HTTP packet; a first seed URL determining unit configured to determine whether or not the extracted first referrer information is seed URL information; a first arrival information extraction unit configured to extract first arrival URL information derived from the seed URL information, when the first referrer information is seed URL information according to the determination result; and a first redirection setting unit configured to set the first arrival URL information as redirection when a final form of the first arrival URL information is one or more of JS, HTML, and PHP forms.

The apparatus may further include: a second seed URL determining unit configured to determine whether or not there is no non-checked seed URL information in the HTTP packet when the extracted first referrer information is not seed URL information according to the determination result; a second arrival information extracting unit configured to extract second arrival URL information derived from the non-checked seed URL information by using the non-checked seed URL information as second referrer information, when there is non-checked seed URL information; and a second redirection setting unit configured to set the second arrival URL information as redirection, when a final form of the extracted second arrival URL information is one or more of JS, HTML, and PHP forms.

When the final form is not the JS, HTML, or the PHP form, the first redirection setting unit may check whether or not a final form of the first arrival URL information does not have ‘.’ up to the end of the address after ‘/’, and when the final form does not have ‘.’, the first redirection setting unit may further set it as redirection.

When the final form is not the JS, HTML, or the PHP form, the second redirection setting unit may check whether or not a final form of the second arrival URL information does not have ‘.’ up to the end of the address after ‘/’, and when the final form does not have ‘.’, the second redirection setting unit may further set it as redirection.

According to another aspect of the present invention, there is provided a method for tracking a network path, including: (a) extracting only an HTTP packet among all the packets generated while a certain Web page is being executed; (b) extracting first referrer information indicating start of the Web page and second referrer information indicating start of a different Web page from the HTTP packet; (c) determining whether or not the extracted first referrer information is seed URL information; (d) when the first referrer information is seed URL information according to the determination result, extracting first arrival URL information derived from the seed URL information; (e) determining whether or not a final form of the extracted first arrival URL information is one or more of JS, HTML, and PHP forms; (f) setting the first arrival URL information as redirection in case of affirmation according to the determination result in (e); and (g) determining whether or not the number of referrer information items checked in (c) to (f) is equal to the number of a total referrer information items of the HTTP packet.

The method may further include: (h) when (g) is affirmative or when the extracted first referrer information is not seed URL information according to the determination result in (c), determining whether or not there is non-checked seed URL information in the HTTP packet; (i) determining whether or not the determined non-checked seed URL information is used as the second referrer information; (j) when it is determined that the determined non-checked seed URL information is used as the second referrer information, extracting second arrival URL information derived from the non-checked seed URL information and determining whether or not a final form thereof is JS, HTML, PHP, or ‘/’; and (k) when (j) is affirmative, setting the second arrival URL information as redirection.

The method may further include: (l) when (e) is negative according to the determination result, determining whether or not a final form of the first arrival URL information does not have ‘.’ up to the end of the address after ‘/’.

When (l) is affirmative according to the determination result, the first arrival URL information may be set as redirection.

The method may further include: (m) when (j) is negative according to the determination result, determining whether or not a final form of the first arrival URL information does not have ‘.’ up to the end of the address after ‘/’.

When (m) is negative according to the determination result, the second arrival URL information may be set as redirection.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating an apparatus 100 for tracking a network path according to a first embodiment of the present invention;

FIG. 2 is a view illustrating a network path relationship according to the first embodiment of the present invention;

FIGS. 3 through 5 are views illustrating network paths located by analyzing HTTP packets according to the first embodiment of the present invention; and

FIG. 6 is a flow chart illustrating a method (S100) for tracking a network path according to a second embodiment of the present invention.

### DETAILED DESCRIPTION OF THE INVENTION

Hereinafter, embodiments will be described in detail with reference to the accompanying drawings such that they can be easily practiced by those skilled in the art to which the present invention pertains. However, the present invention may be implemented in various forms and not limited to the embodiments disclosed hereinafter. Also, similar reference numerals are used for the similar parts throughout the specification.

### First Embodiment

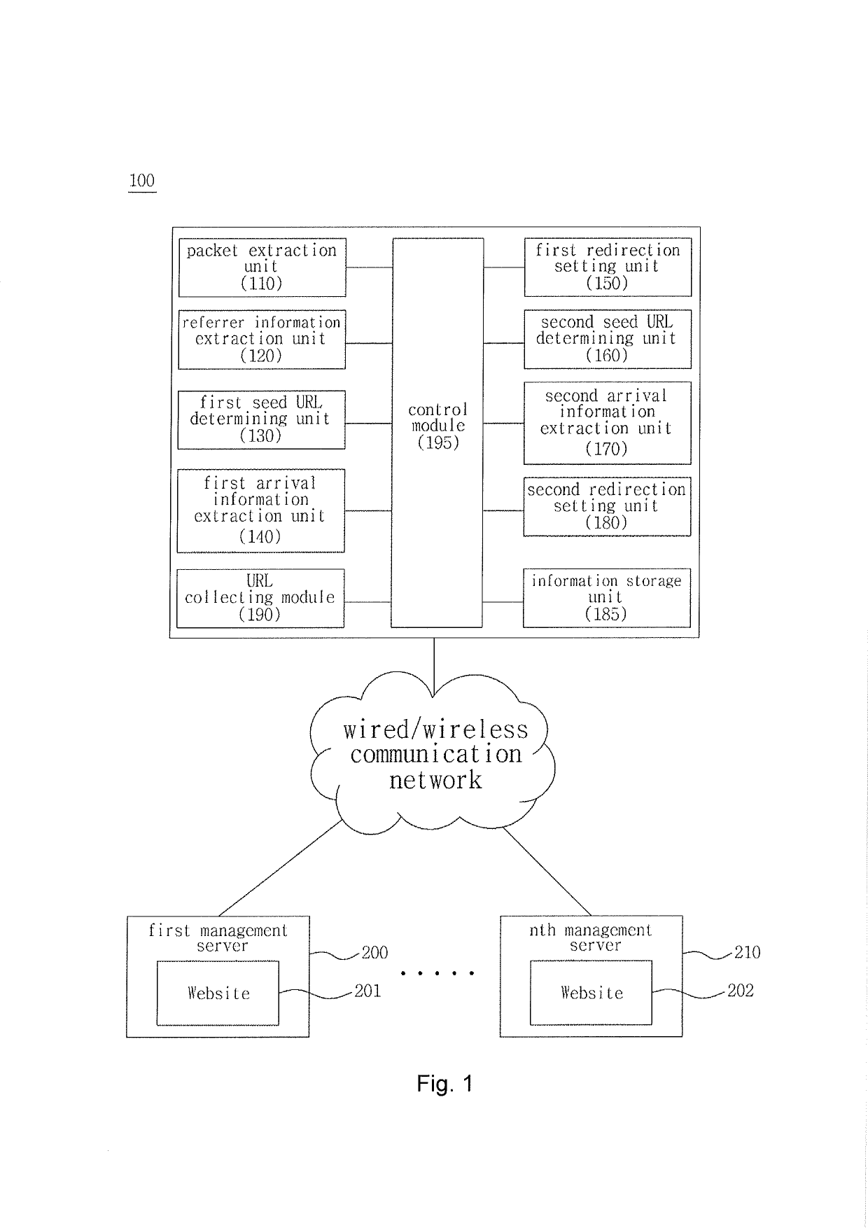

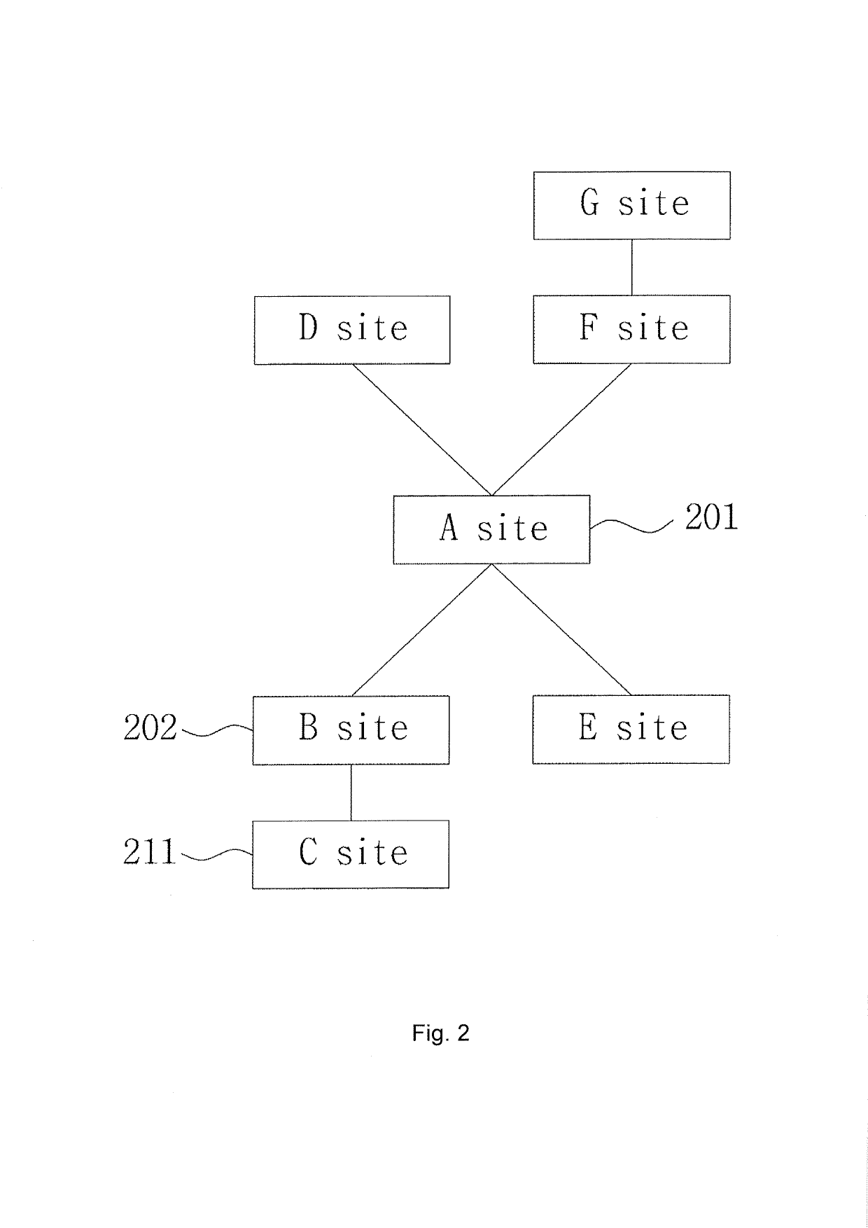

FIG. 1 is a view illustrating an apparatus 100 for tracking a network path according to a first embodiment of the present invention, and FIG. 2 is a view illustrating a network path relationship according to the first embodiment of the present invention.

Referring to FIG. 1, the apparatus 100 for tracking a network path (or a network path tracking apparatus 100) according to a first embodiment of the present invention is an apparatus for locating a source of a malicious code with respect to certain information posted on a particular Web page when a user accesses a management server 200 or 210 managing each Web page (or each Website) 201 or 202, respectively, through a wired/wireless communication network to visit the particular Web page. A plurality of management servers 200 and 210 are provided, and here, it is assumed that the network path tracking apparatus 100 intends to locate a source of a malicious code with respect to information posted on the Web page 201 of the management server 200.

To this end, the network path tracking apparatus 100 is configured to include a packet extraction unit 110, a referrer information extraction unit 120, a first seed URL determining unit 130, a first arrival information extraction unit 140, a first redirection setting unit 150, an information storage unit 185, a communication module 190, and a control module 195.

First, the packet extraction unit 110 visits the Web page (or the Website) 201 managed by the management server 200 and collects all the packets generated while the Web page 201 is being executed. All the packets in this case refer to packet information generated when seed URL information required for accessing the Web page 201 provided by the management server 200 is input.

Although a time for a user to visit and access the Website 201 may superficially be within merely a few seconds, but a good deal of packet is substantially exchanged internally therethrough. For example, a good deal of packet data such as a request message, a response message, and the like, are generated.

In this case, in order to achieve the object of the present invention, the packet extraction unit 110 extracts and collects only HTTP packets. The collected HTTP packet data is classified into a request message, a response message, and the like, and the request message includes various types of information such as referrer information, seed URL information, arrival URL information, and the like.

For example, the collected HTTP packet information (data) includes link information (i.e., referrer information, seed URL information, arrival URL information, and the like, of a different Website) indicating respective sources of various types of information (e.g., news, sports, current events, IT, and the like) posted on the Web page 201.

In general, referrer information refers to referred information remaining in a different website as well as a corresponding website. For example, as illustrated in FIG. 2, on the assumption that the Web page 201 called ‘A’ has a hyperlink moving to B website 202, when the hyperlink is clicked, the A website 201 transmits a reference address to the B website 202. Here, the reference address is called referrer information. In this manner, the A website 201 includes the referrer information.

Similarly, the B website 202 transmits a reference address (referrer information) to C website 211. Here, the B website 202 and the C website 211 has referrer information, respectively. Such referrer information includes a plurality of seed URL information and arrival URL information provided in each website.

The seed URL information refers to URL information indicating start of each website, and the arrival URL information refers to information linked from the seed URL information. Each information is used by a module later.

The referrer information extraction unit 120 extracts first referrer information indicating start of the Web page 201 of the management server 200 and second referrer information indicating start of a different Web page from the collected HTTP packet information. For example, referrer information of the B website illustrated in FIG. 2 may be the second referrer information.

The first seed URL determining unit 130 serves to determine whether or not the extracted first referrer information is seed URL information. Here, the seed URL information refers to a start address. For example, the seed URL information refers to a URL address of the website 201 the user wants to visit. Namely, the first seed URL determining unit 130 determines whether or not the extracted first referrer information is used as seed URL information.

When it is determined that the first referrer information is first seed URL information according to determination results from the firs seed URL determining unit 130, the first arrival information extraction unit 140 serves to extract first URL information derived from the seed URL information. The first arrival URL information refers to linked information, e.g., URL information of an image, present in the management server 200 that manages the Web page 201. In other words, the first arrival URL information refers to Web information managed by the management server 200.

For example, in case that information derived from seed URL information such as “http://www.khan.co.kr/” is “http://news.khan.co.kr/kh_news/khan_art_view.html?artid=201112041850045& code=9 10402”, URL information of “http://news.khan.co.kr/kh_news/khan_art_view.html?artid=201112041850045& code=9 10402” is first arrival URL information. Such first arrival URL information refers to unique link information provided from the pure “http://www.khan.co.kr/(Seed URL)”, rather than information brought through a different website.

The first redirection setting unit 150 serves to check whether or not the first arrival URL information extracted by the first arrival information extraction unit 140 has at least one or more of JS, HTML, and PHP forms, as a final form thereof. When a final form of the first arrival URL information is at least one or more of JS, HTML, and PHP forms, the first redirection setting unit 150 serves to set the first arrival URL information as redirection.

For example, when it is assumed that the first arrival URL information of “http://news.khan.co.kr/kh_news/khan_art_view.html? artid=201112041850045&code=9 10402” has a form such as “/js/livere_lib.js” or “domain/media/khan.co.kr/khan.html”, as a final form, the first redirection setting unit 150 sets the first arrival URL information of “http://news.khan.co.kr/kh_news/khan_art_view.html?artid=201112041850045&code=9 10402”, as redirection.

When the first redirection setting unit 150 sets the first arrival URL information of “http://news.khan.co.kr/kh_news/khan_art_view.html?artid=201112041850045&code=9 10402”, as redirection, it can be known that there is a link relationship of “http://news.khan.co.kr/kh_news/khan_art_view.html?artid=201112041850045&code=9 10402→ “http://www.khan.co.kr/(Seed URL)”.

If, however, the final form of the first arrival URL information is not JS, HTML, or PHP form, the first redirection setting unit 150 may detect whether or not a final form of the first arrival URL information does not have ‘.’ up to the end of the address after ‘/’. When there is no ‘.’, the first redirection setting unit 150 may further set it as redirection.

For example, if a final form of the first arrival URL information is RealMedia/ads/adstream_sx.ads/www.khan.co.kr/news@right3, since ‘.’ is not detected up to the address after the first redirection setting unit 150 sets it as redirection.

In case of setting the redirection in this manner, it can be known that there is a link relationship of RealMedia/ads/adstream_sx.ads/www.khan.co.kr/news@right3 →“http://www.khan.co.kr/(Seed URL)”.

Through such setting of redirection, it can be easily determined that a malicious code has been generated from the management server 200.

The information storage unit 185 serves to store information processed by the packet extraction unit 110, the referrer information extraction unit 120, the first seed URL determining unit 130, the first arrival information extraction unit 140, and the first redirection setting unit 150, and retrieve corresponding information among the stored information and provide the same to each module as necessary.

The information storage unit 150 may be a database (DB) or a storage medium such as a flash memory or a non-flash memory. A DB or a storage medium is a generally widely known storage medium, so a description thereof will be omitted.

The communication module 190 supports a communication interface between the network path tracking apparatus 100 and the management servers 200 and 210 that manage websites. While a particular website is being executed, the communication module 190 collects every packet information (HTTP packet information) in relation to information provided from a website of its own and information provided from a different website.

The control module 195 controls a data flow among the packet extraction unit 110, the referrer information extraction unit 120, the first seed URL determining unit 130, the first arrival information extraction unit 140, the first redirection setting unit 150, and the communication module 190, to thus allow the packet extraction unit 110, the referrer information extraction unit 120, the first seed URL determining unit 130, the first arrival information extraction unit 140, the first redirection setting unit 150, and the communication module 190 to process unique data thereof, respectively.

Meanwhile, the network path tracking apparatus 100 according to the first embodiment of the present invention has been described based on the assumption that referrer information is seed URL information, but in case that referrer information is not seed URL information, a second seed URL determining unit 160, a second arrival information extraction unit 170, and a second redirection setting unit 180 may be used.

Thus, the network path tracking apparatus 100 according to the first embodiment of the present invention may further include the second seed URL determining unit 160, the second arrival information extraction unit 170, and the second redirection setting unit 180.

First, when the referrer information is determined not to be seed URL information according to the determination result of the first seed URL determining unit 130, the second seed URL determining unit 160 serves to determine whether or not there is non-checked seed URL information in the HTTP packet. In other words, the second seed URL determining unit 160 determines whether or not there is URL information provided from a different website, rather than URL information provided from the website 201 of the management server 200.

For example, when the visiting web page 201 is “http://www.khan.co.kr/(seed URL information)” and seed URL information (domain/RealMedia/ads/adstream_sx.ads/www.khan.co.kr/news©x55) having a different form from that of the seed URL information exists in a non-checked state, it may be recognized that the non-checked seed URL information has been provided from a different website. The non-checked seed URL information may be called second seed URL information so as to be differentiated from the first seed URL information.

When the second seed URL determining unit 160 determines that there is non-checked seed URL information and the non-checked seed URL information is used as second referrer information extracted from the referrer information extraction unit 120, the second arrival information extracting unit 170 serves to find second arrival URL information derived from the non-checked seed URL information and extract the same.

For example, domain/RealMedia/ads/adstream_sx.ads/www.khan.co.kr/news@x55 is non-checked seed URL information, and domain/CID1126/240240.swf is recognized as second arrival URL information derived from (linked to) the non-checked seed URL information and extracted.

The second arrival URL information may be information provided from a different neighboring Web page of the Web page 201 or may be information provided from another different neighboring Web page of the different Web page.

Finally, the second redirection setting unit 180 serves to check whether or not the second arrival URL information extracted by the second arrival information extraction unit 170 has at least one or more of JS, HTML, and PHP forms, as a final form thereof. When a final form of the second arrival URL information is at least one or more of JS, HTML, and PHP forms, the second redirection setting unit 180 serves to set the second arrival URL information as redirection.

The redirection setting function has the same principle as that of the redirection setting performed by the first redirection setting unit 150 as described above, so a description thereof will be omitted. In addition, when it is determined that the second arrival URL information does not have any of the JS, HTML, and PHP forms, the second redirection setting unit 180 serves to detect whether or not a final form of the second URL information do not have ‘.’ up to the end of the address after ‘/’.

When the second URL information is determined not to have the foregoing form, the second redirection setting unit 180 sets it as redirection. This setting is performed to have the same function as that of the first redirection setting unit 140.

In this manner, by setting the redirection, although certain information posted on the Web page of the management server 200 is information which has been generated from a network path through several Web pages, a source of a detour server and a Web page which have generated a malicious code can be easily known by tracking the path in the foregoing manner, whereby spreading of the malicious code on the corresponding Web page can be prevented.

In addition, the second seed URL determining unit 160, the second arrival information extracting unit 170, and the second redirection setting unit 180 may perform their unique functions by the control module 185 and the communication module 190.

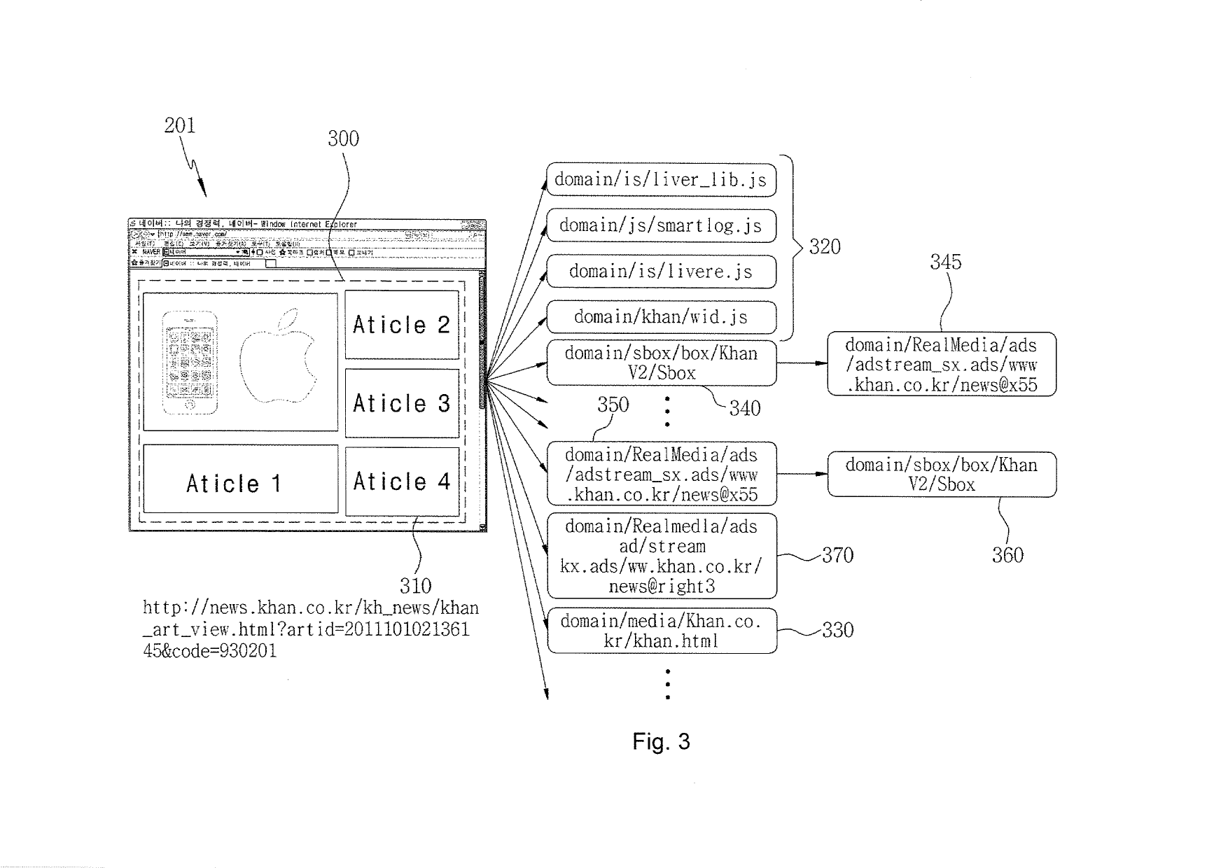

Meanwhile, in which form the referrer information, the first and second seed URL information, and the first and second arrival URL information as described above exist in each of the foregoing modules will be described with reference to FIG. 3.

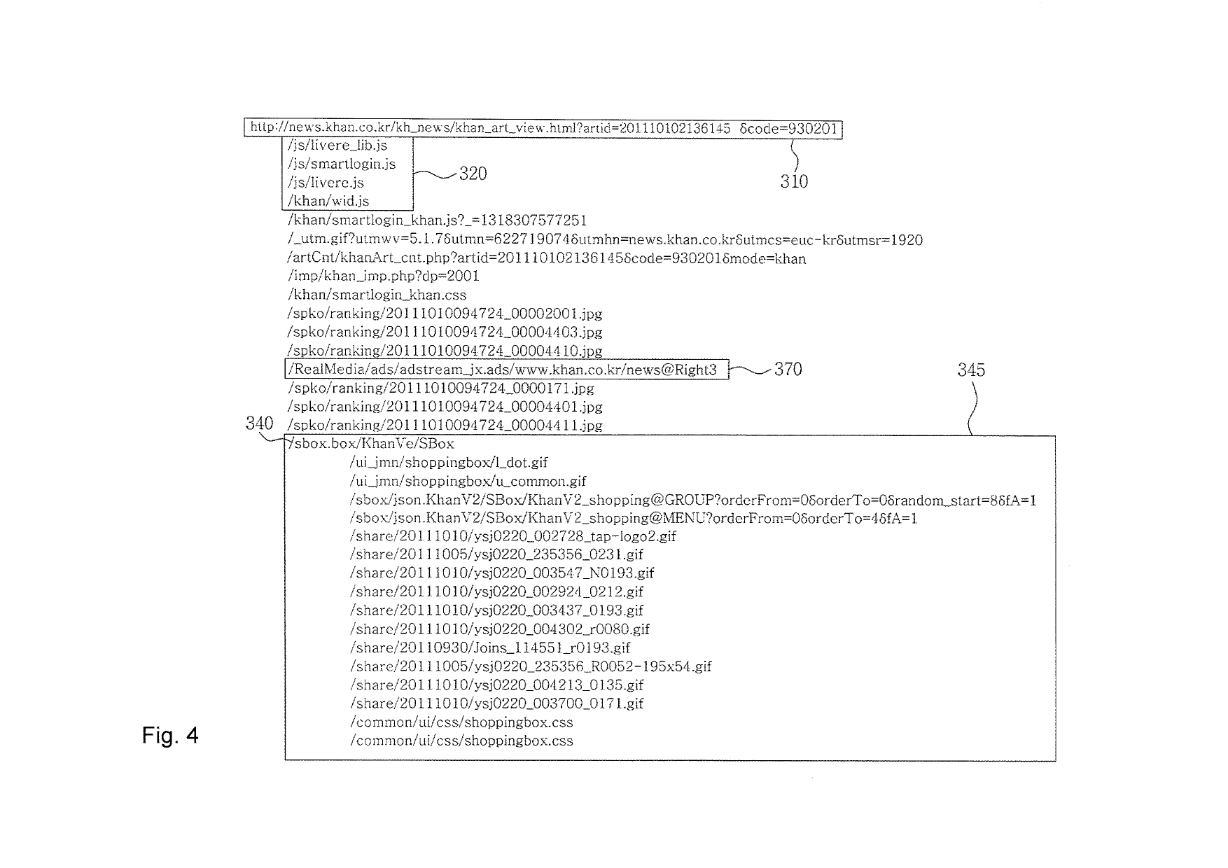

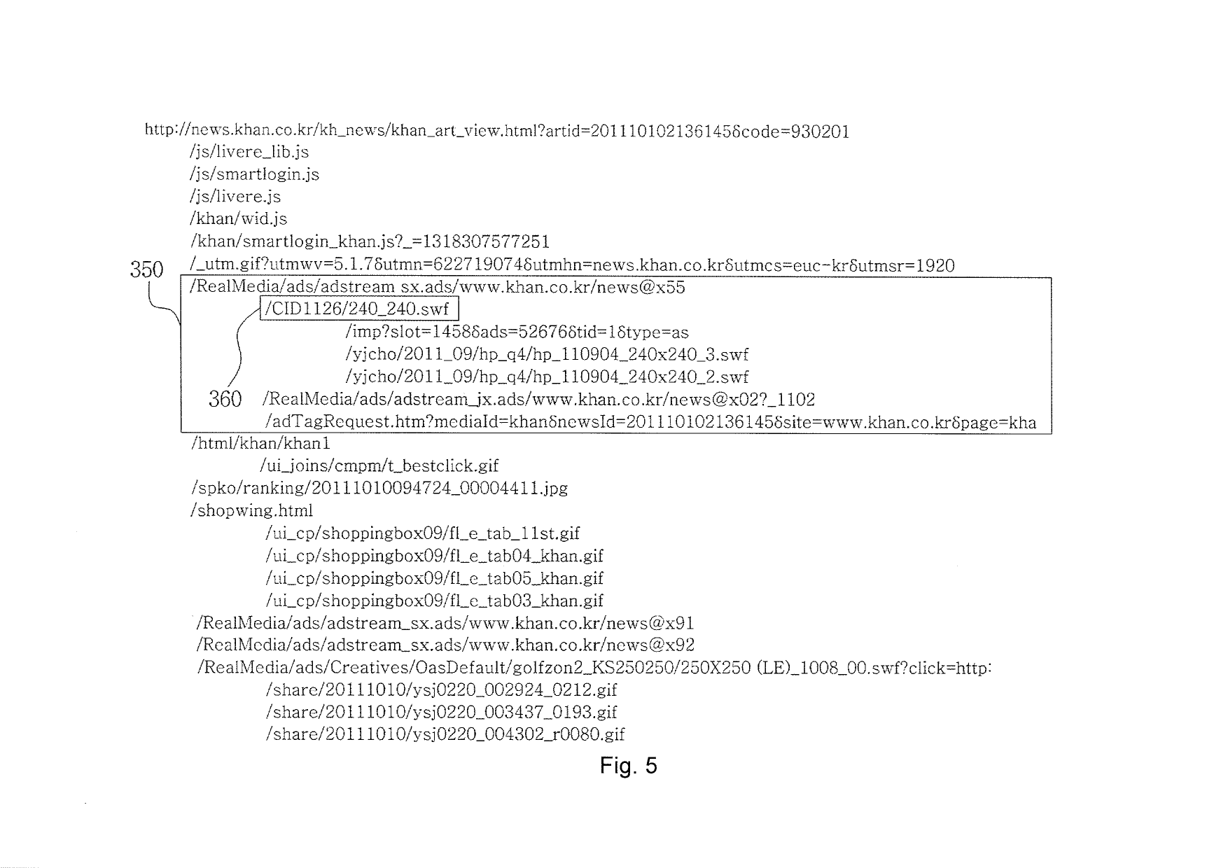

FIGS. 3 through 5 are views illustrating network paths located by analyzing HTTP packets according to the first embodiment of the present invention. FIGS. 3 through 5 are views illustrating network paths located by analyzing HTTP packets according to the first embodiment of the present invention. As illustrated, various types of information 300 are displayed while the Web page 201 provided from the management server 200 is being executed. While such types of information are being displayed, HTTP packet information is collected. Hereinafter, meaning of information found from the collected HTTP packet will be described.

Reference numeral 310 denotes first referrer information derived from (or linked to) a seed URL (http://news.khan.co.kr) as a start address in the corresponding Web page, and reference numerals 320 and 330 denote first arrival URL information derived from the first referrer information, respectively. Here, the URL information of the reference numeral 320 indicates that a final form of the first arrival URL information is JS, and reference numeral 330 denotes that a final form of the first arrival URL information is html.

The foregoing first referrer information and first arrival URL information are URL information provided from the corresponding Web page linked to the seed URL (http://news.khan.co.kr).

Reference numerals 340 and 350 denote different types of non-checked seed URL information provided from different websites, respectively, and reference numerals 345 and 360 denote different types of second arrival URL information derived from the non-checked seed URL information, respectively.

Reference numeral 370 denotes first arrival URL information derived from the first seed URL and indicates a case in which a final form of the first arrival URL information does not have ‘.’ up to the end of the address after ‘/’.

### Second Embodiment

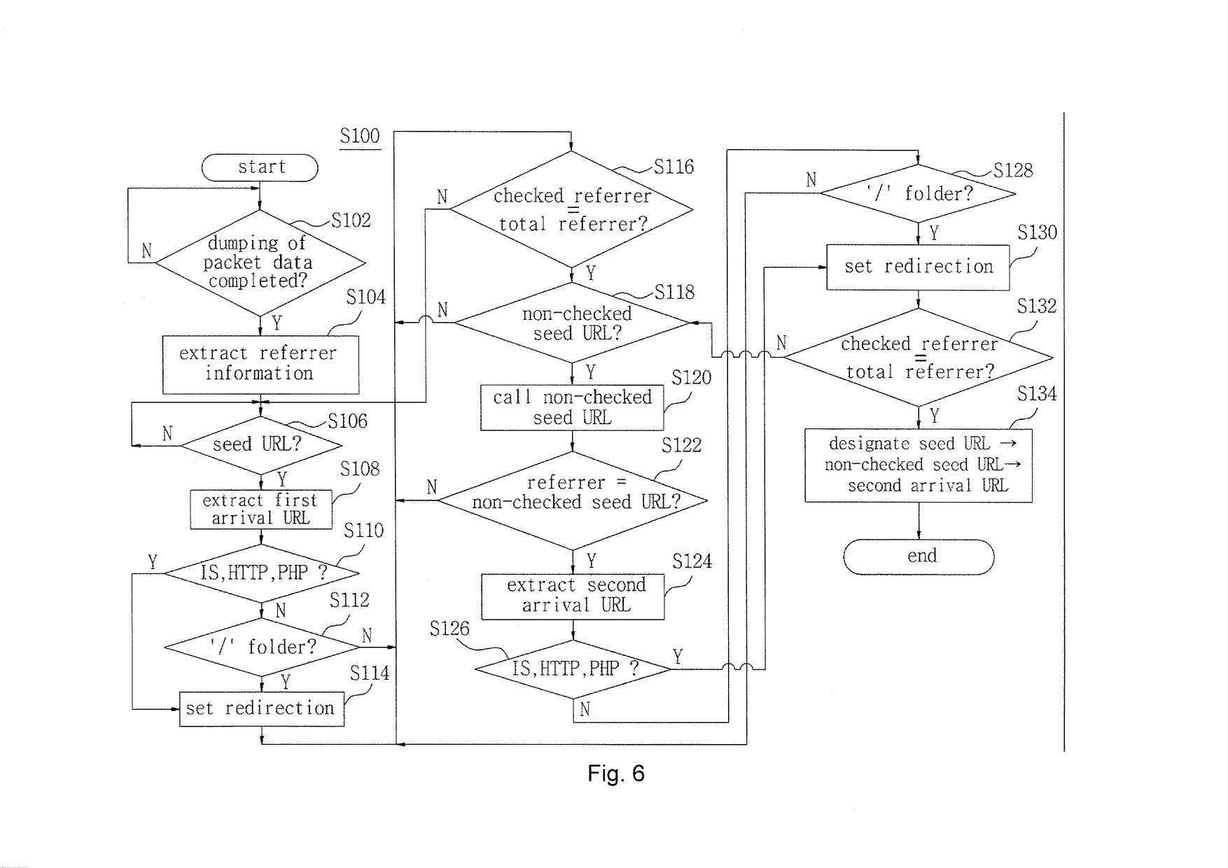

FIG. 6 is a flow chart illustrating a method (S100) for tracking a network path according to a second embodiment of the present invention.

Referring to FIG. 6, the method (S100) for tracking a network path according to the second embodiment of the present invention includes steps S102 to S134 to locate a source of a malicious code with respect to certain information posted on a particular Web page when the Web page is visited.

First, in step S102, it is determined whether or not every packet information, e.g., HTTP packet information, generated while the certain Web page is being executed has been completely dumped. Here, dumping comprehensively refers to extracting, collecting, and storing every packet data, e.g., HTTP packet information.

When it is determined that every HTTP packet information has been completely dumped in step S102, first referrer information and second referrer information are extracted from information included in the HTTP packets in step S104. In this case, when every HTTP packet information has not been completely dumped in step S102, the process may restart or, according to circumferences, step S116 (to be described) may be performed. Here, the first and second referrer information have been sufficiently described with reference to FIGS. 1 to 5, so a repeated description thereof will be omitted.

In step S106, it is determined whether or not the extracted first referrer information is seed URL information. When the first referrer information is determined to be seed URL information, first arrival URL information derived from the seed URL information is extracted in step S108. The first arrival URL information refers to link information generated from a different website. The first arrival URL information has been sufficiently described with reference to FIGS. 1 to 5, so a repeated description thereof will be omitted.

In step S110, it is determined whether or not a final form of the first arrival URL information extracted in step S108 is one or more of JS, HTML, and PHP forms. In case of affirmation (YES) according to the determination result, step S114 is performed, or otherwise, step S112 is performed.

In case of negation (NO) according to the determination result in step S110, it is determined whether or not a final form of the first arrival URL information does not have ‘.’ up to the end of the address after ‘/’ in step S112. In case of affirmation according to the determination result, step S114 is performed, or otherwise, step S116 is performed.

In case of affirmation in step S110 or in case of affirmation in step S112, the first arrival URL information is set as redirection in step S114. When the first arrival URL information is set as redirection, a relationship of seed URL→first arrival URL can be known.

In step S116, it is determined whether or not the number of referrer information checked in steps S104 to S112 is equal to the number of a total of the referrer information within the HTTP packets.

When the numbers are equal according to the determination result, it is regarded that the entire checking in steps S102 to S114 has been completed and step S118 is performed, or otherwise, the process is returned to step S106 for retry.

In step S118, it is determined whether or not there is non-checked seed URL information (in case that it is not a seed URL) in the HTTP packets. Here, the non-checked seed URL information refers to URL information brought from an external different website, rather than information provided from the corresponding Web page. In case of affirmation according to the determination result, step S120 is performed, or otherwise, the process is stopped.

In step S120, when it is determined that there is non-checked seed URL information, the non-checked seed URL information is called (or extracted). Thereafter, in step S122, it is determined whether or not the called non-checked seed URL information is used as second referrer information extracted in step S104. In case of affirmation, step S122 is performed, or otherwise, the process is returned to step S116.

In step S124, in case of affirmation according to the determination result in step S120, the second arrival URL information derived from the non-checked seed URL information is checked to extract second arrival URL information. In step S126, it is determined whether or not a final form of the second arrival URL information is JS, HTML, PHP, or ‘/’. In case of affirmation, step S130 is performed, and in case of negation, step S128 is performed.

In step S128, in case of negation according to the determination result in step S126 (i.e., in case of NO), it is determined whether or not a final form of the extracted second arrival URL information does not have ‘.’ up to the end of the address after ‘/’. When the final form of the extracted second arrival URL information does not have step S130 is performed, or otherwise, the process is returned to step S116.

In step S130, in case of affirmation in step S126 or in case of affirmation in step S128, the extracted second arrival URL information is set as redirection. Thereafter, in step S132, it is determined whether or not the number of referrer information items checked in steps S104 to S130 is equal to the number of total referrer information items in the HTTP packets. When the numbers are equal, it is regarded that every referrer information within the HTTP packets have been completely checked and step S134 is performed, or otherwise, step S118 is performed.

Finally, in step S134, a relationship of seed URL (non-checked seed URL (second arrival URL due to the redirection setting in step S128 is designated.

Meanwhile, the forms of the referrer information, seed URL information, and the arrival URL information as described above can be sufficiently known from FIGS. 3 to 5. Thus, the examples of FIGS. 3 to 5 may also be applied to the second embodiment of the present invention.

Through redirection setting, although certain information posted on the Web page 201 of the management server 200 is information generated from a network path through several Web pages or is information provided in itself, the path can be easily tracked in the foregoing manner, whereby spreading of a malicious code in a Web page can be reduced.

As set forth above, according to embodiments of the invention, referrer information, seed information, and arrival information are extracted by using HTTP packet information generated while a particular Web page is being executed, whereby an infection path of malicious codes generated in several Web pages can be checked, thus preventing infection of a malicious code generated in Web pages.

Also, although information is posted on a Web page through several paths, whether or not arrival URL information has a JS, HTML, or PHP form or ‘/’ form or whether or not there is no ‘.’ up to the end of an address after ‘/’ is checked and redirection is set, whereby a network dissemination path of a malicious code can be easily checked.

While the present invention has been shown and described in connection with the embodiments, it will be apparent to those skilled in the art that modifications and variations can be made without departing from the spirit and scope of the invention as defined by the appended claims.

What is claimed is:

1. An apparatus for tracking a network path, the apparatus comprising:
a packet extraction unit configured to extract only an HTTP packet among all the packets generated while a certain Web page is being executed;
a referrer information extraction unit configured to extract first referrer information indicating start of the Web page and second referrer information indicating start of a different Web page from the HTTP packet;
a first seed URL determining unit configured to determine whether or not the extracted first referrer information is seed URL information;
a first arrival information extraction unit configured to extract first arrival URL information derived from the seed URL information, when the first referrer information is seed URL information according to the determination result; and
a first redirection setting unit configured to set the first arrival URL information as redirection when a final form of the first arrival URL information is one or more of JS, HTML, and PHP forms.

2. The apparatus of claim 1, further comprising:
a second seed URL determining unit configured to determine whether or not there is no non-checked seed URL information in the HTTP packet when the extracted first referrer information is not seed URL information according to the determination result;
a second arrival information extracting unit configured to extract second arrival URL information derived from the non-checked seed URL information by using the non-checked seed URL information as second referrer information, when there is non-checked seed URL information; and
a second redirection setting unit configured to set the second arrival URL information as redirection, when a final form of the extracted second arrival URL information is one or more of JS, HTML, and PHP forms.

3. The apparatus of claim 1, wherein when the final form is not the JS, HTML, or the PHP form, the first redirection setting unit checks whether or not a final form of the first arrival URL information does not have ‘.’ up to the end of the address after ‘/’, and when the final form does not have ‘.’, the first redirection setting unit further sets it as redirection.

4. The apparatus of claim 2, wherein when the final form is not the JS, HTML, or the PHP form, the second redirection setting unit checks whether or not a final form of the second arrival URL information does not have ‘.’ up to the end of the address after ‘/’, and when the final form does not have ‘.’, the second redirection setting unit further sets it as redirection.

5. A method for tracking a network path, the method comprising:
(a) extracting only an HTTP packet among all the packets generated while a certain Web page is being executed;
(b) extracting first referrer information indicating start of the Web page and second referrer information indicating start of a different Web page from the HTTP packet;
(c) determining whether or not the extracted first referrer information is seed URL information;
(d) when the first referrer information is seed URL information according to the determination result, extracting first arrival URL information derived from the seed URL information;
(e) determining whether or not a final form of the extracted first arrival URL information is one or more of JS, HTML, and PHP forms;
(f) setting the first arrival URL information as redirection in case of affirmation according to the determination result in (e); and
(g) determining whether or not the number of referrer information items checked in (c) to (f) is equal to the number of a total referrer information items of the HTTP packet.

6. The method of claim 5, further comprising:
(h) when (g) is affirmative or when the extracted first referrer information is not seed URL information according to the determination result in (c), determining whether or not there is non-checked seed URL information in the HTTP packet;
(i) determining whether or not the determined non-checked seed URL information is used as the second referrer information;
(j) when it is determined that the determined non-checked seed URL information is used as the second referrer information, extracting second arrival URL information derived from the non-checked seed URL information and determining whether or not a final form thereof is JS, HTML, PHP, or ‘/’; and
(k) when (j) is affirmative, setting the second arrival URL information as redirection.

7. The method of claim 5, further comprising:
(l) when (e) is negative according to the determination result, determining whether or not a final form of the first arrival URL information does not have ‘.’ up to the end of the address after ‘/’.

8. The method of claim 7, wherein when (l) is affirmative according to the determination result, the first arrival URL information is set as redirection.

9. The method of claim 5, further comprising:
(m) when (j) is negative according to the determination result, determining whether or not a final form of the first arrival URL information does not have ‘.’ up to the end of the address after ‘/’.

10. The method of claim 9, wherein when (m) is negative according to the determination result, the second arrival URL information is set as redirection.
